(19) United States
(12) Patent Application Publication
(10) Pub. No.: US 2014/0042198 A1
(43) Pub. Date: Feb. 13, 2014

(54) Universal, adjustable, stowable electronic tablet housing kit and arm mounting kit for forklifts

(71) Applicants: Ramesh James, Jamaica, NY (US); Li Zhao, North Babylon, NY (US)

(72) Inventors: Ramesh James, Jamaica, NY (US); Li Zhao, North Babylon, NY (US)

(21) Appl. No.: 13/570,619

(22) Filed: Aug. 9, 2012

(51) Int. Cl. B60R 7/04

(52) U.S. Cl. 224/401

(57) ABSTRACT

This device is used to integrate the electronic tablet technology (ex: iPad) on a forklift by way of a universal, adjustable, retractable and stow-able mounting kit complete with electronic charging system prewired ready to install and constructed of heavy duty grade steel to meet the rugged and harsh operating environments of cargo, storage and supply warehouses and facilities. Currently there are no versions of an electronic tablet mount for forklifts. This device has a universal mounting clamp that attaches to the forklift frame. The arm consists of the clamp, extension arm and tablet mounting case equipped with built-in charging wiring to be connected to the forklifts battery source.

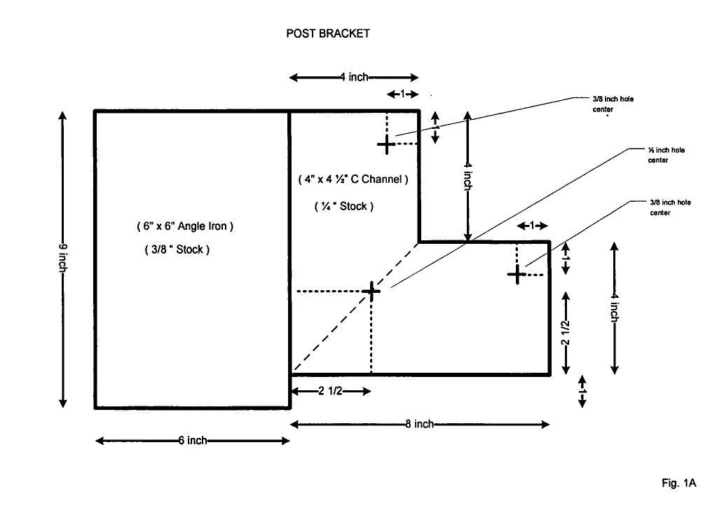

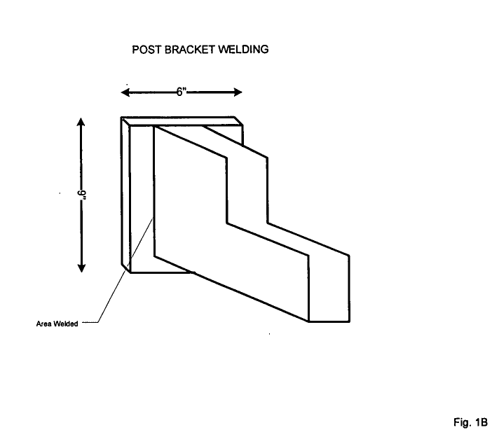

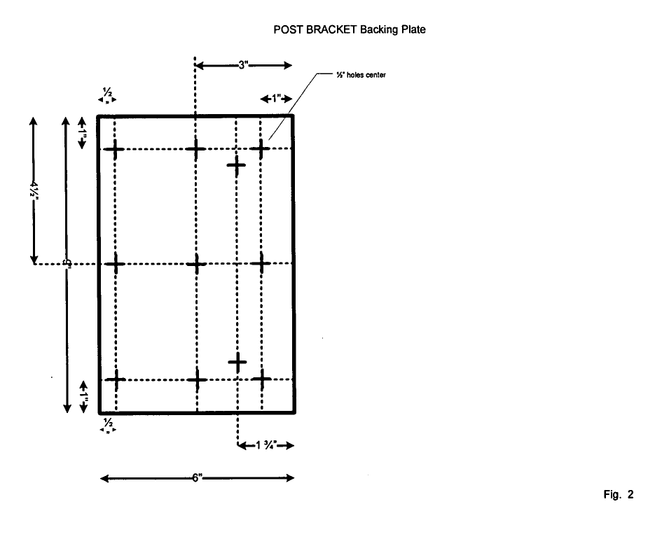

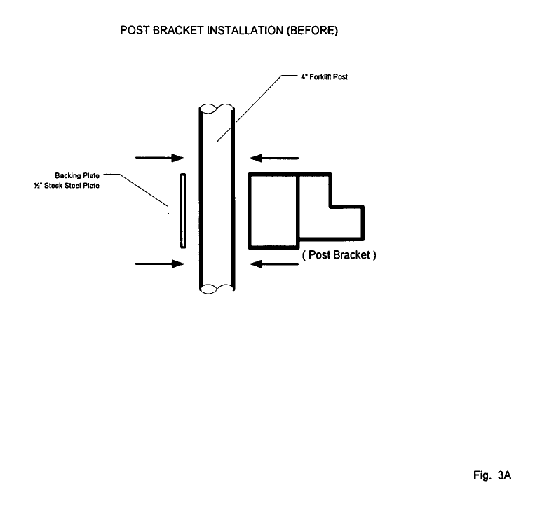

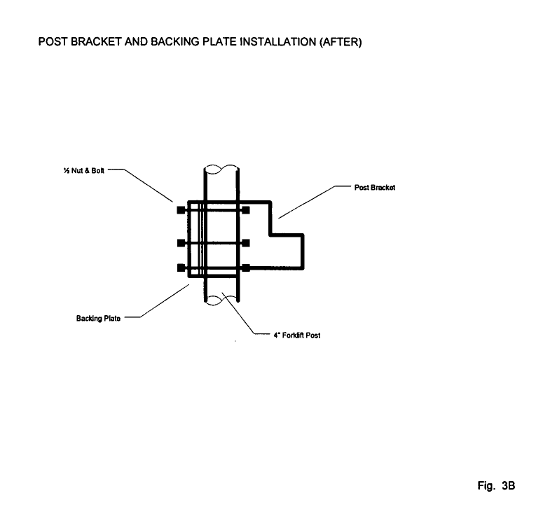

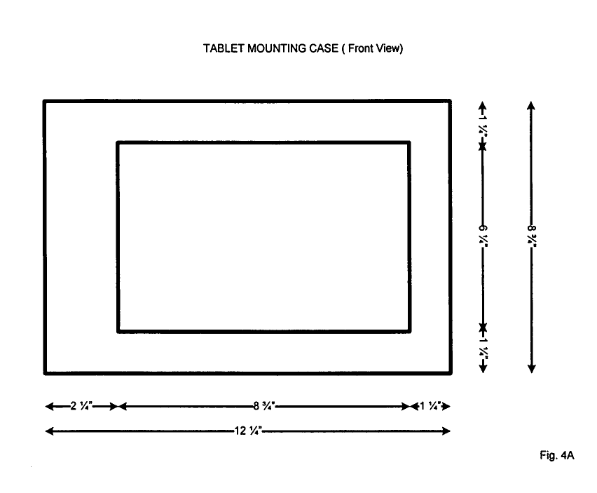

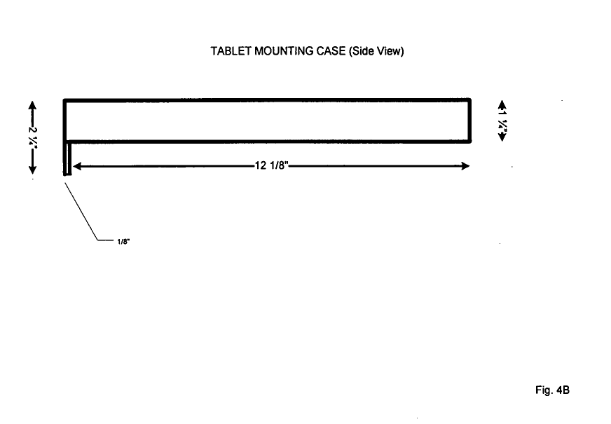

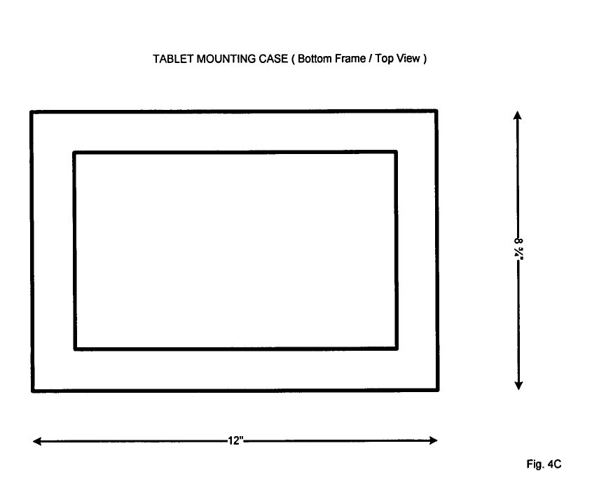

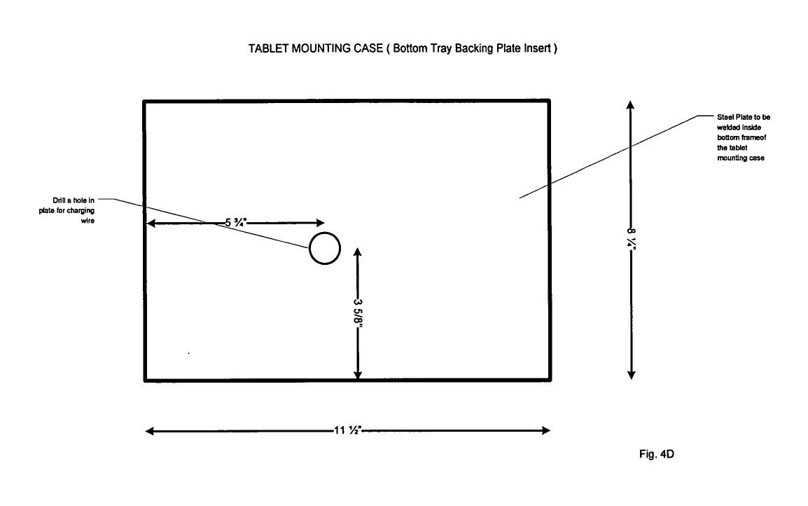

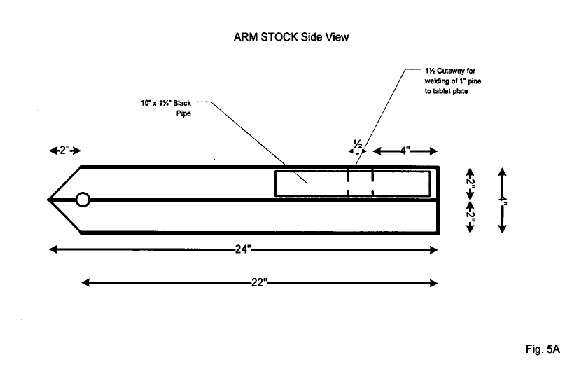

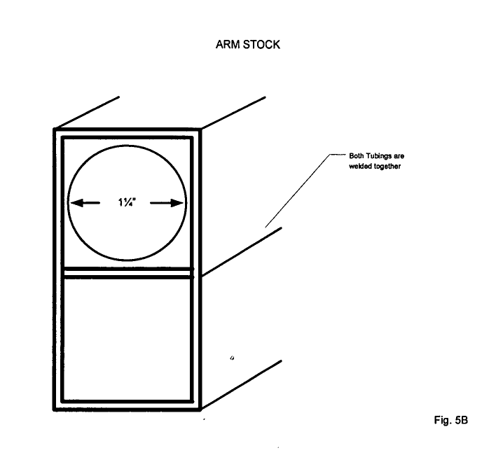

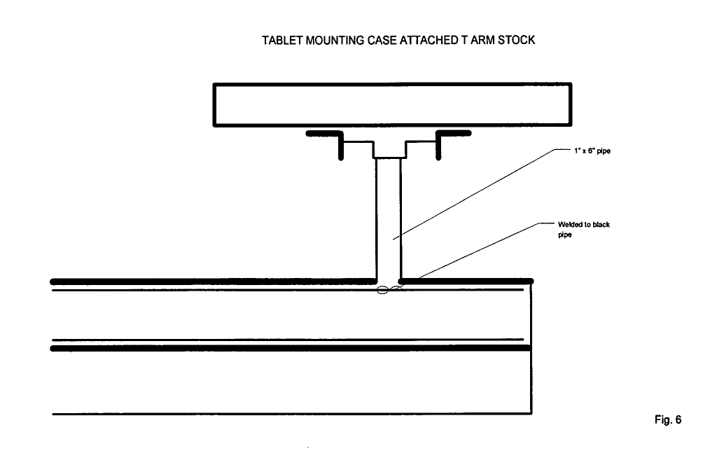

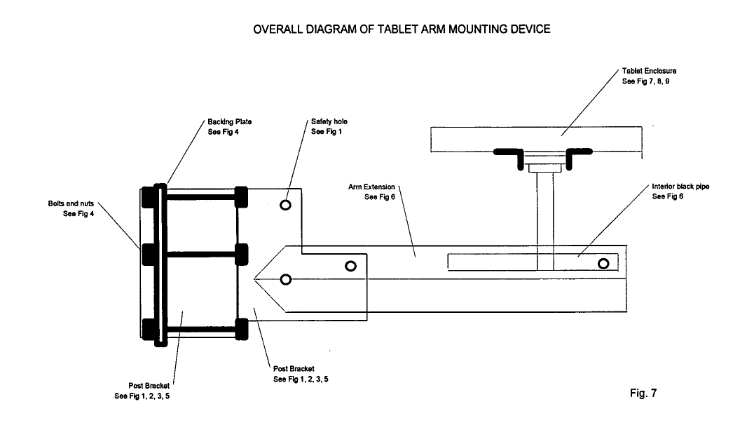

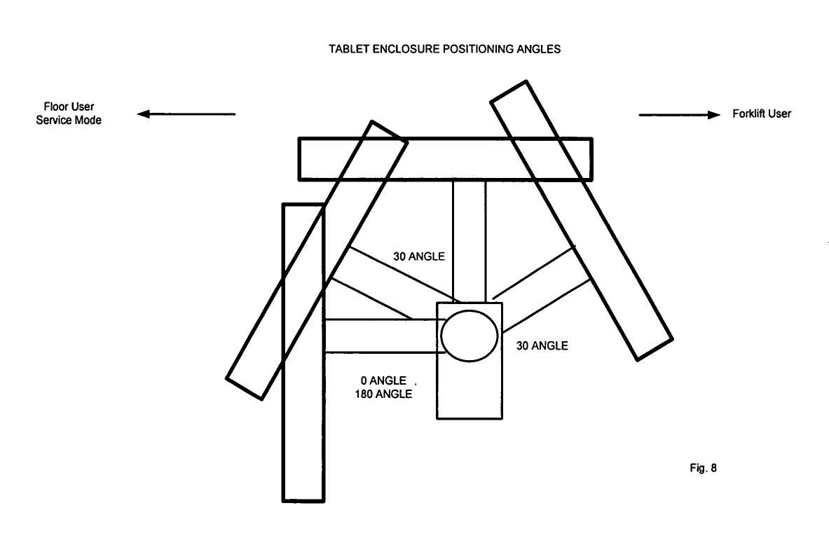

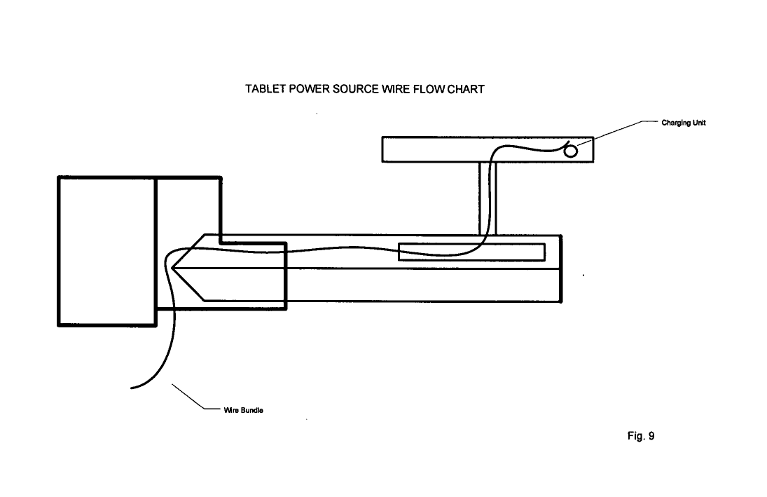

### BACKGROUND OF THE INVENTION

This invention makes it feasible for electronic tablets such as iPad to be deployed in the warehouse/workspace constantly connecting the forklift operator with data center by using and updating with real-time information. The device allows for the integration of this technology to make a warehouse/workspace mobile device centric operation possible. Both the forklift and its operator and the use of advanced technology are necessary. There is no way to merge the two without the use of the invention.

With the electronic tablet attached to the forklift by way of the universal electronic tablet mounting invention, the forklift operator will be able to use the electronic tablet such as iPad as a fixed device on a forklift, interacting with data center.

The forklift user will use the electronic tablet to check on and input information regarding material handling such as assembling, dissembling, deliveries, acceptances, instant messaging with control center, etc.

This device puts the access to all these functions at the operator's fingertips, resulting in the decrease of delays due to traditional human interaction and communication, decrease of fuel usage and bulk printing and paper usage and cost.

### BRIEF SUMMARY OF THE INVENTION

The present invention relates to a universal, adjustable, stow-able electronic tablet housing and arm mounting kit for forklifts.

This device is designed to mount an electronic tablet device such as iPad within working range of a forklift operator. If the arm extension bracket was positioned elsewhere and the arm extension mounted upside down, it will still deliver a tablet position to be used by the forklift operator. There is a defined position intended for this device but it is not limited to this area of installation. It is a universal, adjustable, retractable, storable device. These components in this invention can be re-arranged to perform the intended functions at the user's discretion.

To utilize the electronic tablet mounting arm (the invention) the forklift operator will be able to use the tablet that is mounted next to him/her. While positioned in “forklift user” mode, the operator can easily use the touch screen with their fingertips. If the operator dismounts the forklift and wants to work on the floor, he/she can easily pull the tablet positioning safety pin out and swivel the mount 90 degrees to “floor use” and reinsert the safety pin to secure the tablet case from moving. In case the forklift needs to be serviced, the tablet safety positioning pin is pulled out and the tablet positioned in “service use” mode and safety pin reinstalled. Then the user can pull the arm positioning safety pin to fold the arm in the upwards position and secure the pin in the “store” position. This will allow the tablet case and the arm to be safely stored and out of the way of servicing.

This device may also be used in the following ways:

1. The tablet case can be retro-fitted to hold traditional notepads, receipt and invoice books and other types of electronic tablet technologies.

2. The arm can be mounted to beams, posts, pipes and even the wall inside of workshops, warehouses and service stations as a retractable and storable mount for a door/counter electronic tablet, television or even security screen display.

There are no universal mounting kits for an electronic tablet (ex: iPad) and its technology rugged enough for use on a forklift. The construction of this device is built with industrial steel yet very user friendly with adjustable and stow-able features.

### BRIEF DESCRIPTION OF THE SEVERAL VIEWS OF THE DRAWING

The device is comprised of two major components: an arm extension bracket and the arm extension/tablet mount.

1. The arm extension bracket consists of:

A. Arm extension bracket predrilled mounting holes. The bracket also has a right angle channel pre-welded on it for installing the arm extension/tablet mounting case.

There is a hole pre-drilled in the bracket for a locking pin used to attach the arm to the bracket.

There is also another hole pre-drilled for a safety pin that is used to store the arm extension in either “user” or “service” modes.

B. Locking pin is installed when attaching the arm extension to the arm extension bracket.

C. Safety pin is used to lock the arm in either “user” or “service” modes.

D. Backing plate pre-drilled with holes matching the holes drilled in the arm mounting bracket.

E. Nuts, bolts and lock washers are used to fasten the arm extension bracket and backing plate to the forklift/post.

F. There is a hole drilled with a tube insert used to feed the charging wiring system through the mounting bracket into the post/beam of the forklift on other intended use.

G. There is a locking component designed to protect the bracket fastening components from being tampered with.

2. The arm extension/tablet mounting case (combined as one unit).

A. The arm has a hole pre-drilled to attach to the arm extension bracket using the locking pin to secure the two together.

B. Another hole is pre-drilled for a safety pin to lock the arm in either “user” or “service” mode. This safety pin is used between the arm extension and the arm extension bracket.

C. There is one other hole pre-drilled near the tablet mounting case used with a safety pin for positioning the mounting case in 3 different positions (forklift user, floor user and service use).

D. Safety pin attached to arm with braided wire for use with the tablet mounting case positioning (optional).

E. Tablet mounting case is a two piece case with hinges welded on the left-hand side (based on sitting in the forklift user position). There are two locking mechanisms mounted on the left side. Inside the mounting case has a pre-drilled hole in the middle of the case to allow for the charging system wiring to run through the arm and into the forklift post.

F. Inside the mounting case may house the charging system wiring built-it into the unit and run through the arm extension depending on the type of electronic tablet used.

G. There is a steel tubing welded behind the tablet mounting case into a steel pipe that is run through the arm extension. There is a cut-away section of the arm that will allow for the pipe to swivel 180 degrees. There will be three positions pre-drilled in the arm and pipe inside the arm for positioning of the tablet (forklift user, floor user and service use).

### DETAILED DESCRIPTION OF THE INVENTION

The following steps are taken to make this invention:

1. You would have to measure the length between the forklift posts (front to back and on the side where the blade controls are positioned).

2. Then measure three positions of the seating for the forklift operator (seat all the way forward, in the middle and all the way to the back)

3. Determine the distance from the rear post of the forklift and a general user position and angle of the tablet.

4. Determine if the arm that will be constructed will interfere with the servicing of the forklift, using of the forklift and if the operator can dismount the forklift on the same side the intended device will be mounted on (optional).

5. Determine how to store the device out of the way of the forklift user and forklift service department.

6. After figuring out where you may mount the device, determine what angle the tablet should be positioned as if the operator of the forklift was on the floor, and what angle to store away.

7. Pay close attention to the different types of forklifts that are within and around your working space to insure that the device can be mounted to several different forklift models.

8. Draw basic designs.

9. Fabricate rough model.

10. Fine tune and create safety and security features.

11. Experiment with different electrical charging system.

12. Finalized design after the model has been in use.

13. Get feedback from operators.

14. Paint and enjoy.

1. What is claimed is a universal, adjustable, stow-able electronic tablet housing and arm mounting kit for forklifts.
